(19) United States
(12) Patent Application Publication
(10) Pub. No.: US 2018/0174069 A1
(43) Pub. Date: Jun. 21, 2018

(54) SYSTEM AND METHOD FOR IMPROVING PROBLEMATIC INFORMATION TECHNOLOGY DEVICE PREDICTION USING OUTLIERS

(71) Applicant: International Business Machines Corporation, Armonk, NY (US)

(72) Inventors: Rhonda L. Childress, Austin, TX (US); Michael E. Nidd, Zurich (CH); Michelle Rivers, Marietta, GA (US); George E. Stark, Lakeway, TX (US); Srinivas B. Tummalapenta, Broomfield, CO (US); Dorothea Wiesmann, Oberrieden (CH)

(21) Appl. No.: 15/381,096

(22) Filed: Dec. 15, 2016

(51) Int. Cl. G06N 99/00; H04L 12/751

(52) U.S. Cl. CPC G06N 99/005; H04L 45/08

(57) ABSTRACT

A computer-implemented method of increasing reliability of an information technology environment comprising a plurality of hardware devices. Training data is received and a random forest is built from the training data using machine learning. A particular hardware device in the plurality of hardware devices is determined to be strange. Strange is defined as the particular hardware device having a proximity value lower than a predetermined threshold value for the random forest. A preventative action is determined to lower a risk of failure of the particular hardware device. The preventative action is reported. Reporting includes at least one of displaying a report on a display device, printing the report onto paper, and storing the report in a non-transitory computer recordable storage medium.

### BACKGROUND

### 1. Field

The disclosure relates generally to computer security, and more specifically, to techniques for automatically identifying information technology hardware devices that may become problematic from among a large number of hardware devices.

### 2. Description of the Related Art

As used herein, the term “information technology environment” refers to a relatively large number of information technology hardware devices such as servers, routers, firewalls, hubs, work stations, storage devices and other computer-related physical devices. Some of these hardware devices also can be implemented as virtual devices, such as virtual firewalls. Typically, but not necessarily, hardware devices are kept at a common physical location, though an information technology environment may be distributed among different physical locations in some cases. The term “relatively large” depends on user needs and the goal of the entity responsible for the information technology environment, though typically “relatively large” means at least dozens, and typically hundreds of hardware devices all directed towards forwarding the goal of the entity. A large information technology environment may include thousands of hardware devices or more. An “information technology environment” may also be referred to as a “server farm” in some cases, and in other cases might be referred to as an “infrastructure as a service enterprise.”

Thus, information technology environments come in various sizes; however, medium to large information technology environments maintain hundreds of hardware devices. However, hardware devices have somewhat unpredictable failure rates. Failure of hardware devices may be unacceptable if failure leads to loss of information, of the entity's ability to provide a service, of revenue, of reputation, or leads to the consumption of network bandwidth to recover and restore the data.

### SUMMARY

A computer-implemented method of increasing reliability of an information technology environment comprising a plurality of hardware devices. The method includes receiving, at a processor, training data, wherein the training data comprises a plurality of feature sets corresponding to the plurality of hardware devices and also comprises a plurality of failures corresponding to the plurality of hardware devices, wherein the plurality of feature sets represent configurations and descriptions of individual hardware devices in the plurality of hardware devices, and wherein the plurality of failures describe corresponding failures of individual hardware devices in the plurality of hardware devices. The method also includes building, using the processor, a random forest from the training data using machine learning. The method also includes determining, by the processor, that a particular hardware device in the plurality of hardware devices is strange, wherein strange is defined as the particular hardware device having a proximity value lower than a predetermined threshold value for the random forest, and wherein proximity is defined as a tendency of a particular feature set and a particular failure rate for the particular hardware device to be within a same leaf of the random forest as other feature sets and failure rates of ones of hardware devices in the plurality of hardware devices. The method also includes determining, using the processor, a preventative action to lower a risk of failure of the particular hardware device. The method also includes reporting, using the processor, the preventative action, wherein reporting comprises at least one of displaying a report on a display device, printing the report onto paper, and storing the report in a non-transitory computer recordable storage medium.

The illustrative embodiments also provide for a computer including program code for performing the above method. The illustrative embodiments also provide for a non-transitory computer recordable storage medium storing program code for performing the above method.

### BRIEF DESCRIPTION OF THE DRAWINGS

FIG. 1 is a block diagram of an information technology environment, in accordance with an illustrative embodiment;

FIG. 2 is a flowchart of a computer implemented method, in accordance with an illustrative embodiment;

FIG. 3 is a graph of a current classification based on a binary threshold, in accordance with an illustrative embodiment;

FIG. 4 is a graph of improved accuracy based on outlier measures relative to the current classification shown in FIG. 2, in accordance with an illustrative embodiment;

FIG. 5 is a flowchart of a computer-implemented method, in accordance with an illustrative embodiment; and

FIG. 6 is a diagram of a data processing system, in accordance with an illustrative embodiment.

### DETAILED DESCRIPTION

The illustrative embodiments provide for identifying incident risk of devices and reducing this risk through preventative means. Thus, the illustrative embodiments provide for improving productivity and ensuring continued operation of devices within an information technology environment.

The illustrative embodiments also provide for quantification of device incident risk. The illustrative embodiments recommend preventative actions to reduce the risk of incidents. The illustrative embodiments reduce business outages because of device failures for incorrect configurations or capacity issues due to incorrect sizing or placement of a device or devices. The illustrative embodiments recognize and take into account that prioritization by confidence increases the value of recommended maintenance activities.

The illustrative embodiments recognize and take into account that machine learning can be used to identify potentially problematic hardware devices in an information technology environment. Machine learning is a software or firmware technology that gives a computer the ability to “learn” without being explicitly programmed. Machine learning may also be described as computer algorithms (programs) that can learn from and make predictions on data.

The illustrative embodiments use a random forest as part of the machine learning process. A random forest is a “forest” of tree classifiers used to give a combined output for an input set of features. A random forest is built from numerous feature sets of training data for which the correct (most desirable) output is known. A forest of tree classifiers uses a number of decision trees in order to improve the classification rate. More broadly, decision tree learning uses a decision tree as a predictive model which maps observations about an item (represented in the branches) to conclusions about the item's target value (represented in the leaves). Decision tree learning is one of the predictive modelling approaches used in statistics, data mining, and machine learning.

The illustrative embodiments provide for determining the proximity of sets of training data in a machine learning application. Two sets of training data can be said to have close proximity if they are categorized into the same leaf of a number of trees in a given forest. The more often they are used in the same leaf, the stronger their proximity.

The illustrative embodiments recognize and take into account that feature sets in machine learning have a high strangeness measure if they have low proximity to all other sets. A strangeness measure is, again, feature sets having a low proximity to all other sets. The strangeness measure describes an element of the training set that is not very like other elements of the training set, that is has low proximity with other elements of the training set, that produce similar output from the model, which is a random forest. Strangeness may be a sliding scale. The stranger a particular hardware device is, the less the prediction is trusted. This strangeness may be improved by weighting the proximity by the similarity of either the final output for both values or, if they are both contained in training data, the similarity of their desired output. The illustrative embodiments also recognize and take into account that the output of the forest for a feature set with a low strangeness value (i.e. a feature set that is typical of those used in building the forest) should be considered to be more reliable than the output for a feature set with a high strangeness value.

The illustrative embodiments provide for several improvements over prior techniques for using machine learning to identify potentially problematic devices. For example, the illustrative embodiments improve problematic device discrimination through outlier analysis. In contrast, prior techniques identify problematic devices using binary threshold probability. In another example, the illustrative embodiments identify the best variable or variables to augment the base model output even if input data is inconsistent. In contrast, for prior techniques, model prediction is not attainable with inconsistent data. In yet another example, the illustrative embodiments prioritize variables for expert analysis. In contrast, prior techniques provide no underlying variable recommendations.

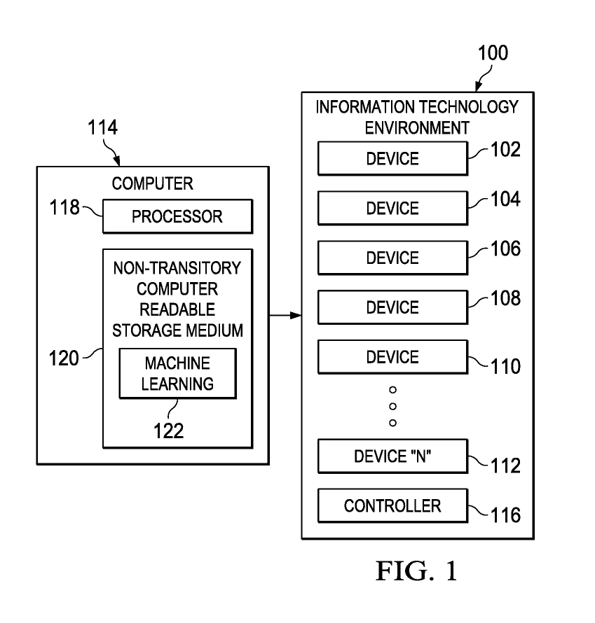

FIG. 1 is a block diagram of an information technology environment, in accordance with an illustrative embodiment. Information technology environment 100 includes at least two, but typically hundreds of hardware devices such as device 102, device 104, device 106, device 108, device 110, and possibly many other devices as represented by device “N” 112. Each device could be a computer, a router, a server, a hub, a storage device, wiring, cabling, or any piece of hardware useful in creating and sustaining information technology environment 100.

In an illustrative embodiment, one or more of the devices in information technology environment 100 may be prone to failure for one reason or another. As used herein, the term “failure” contemplates a device operating in a manner other than a desired manner, interrupted communication with a device, a physical fault in a device, a firmware or software fault in a device, or complete non-operation of the device. The illustrative embodiments contemplate predicting which device or devices in information technology environment 100 are prone to failure so that action may be taken to prevent the failure. Actions include but are not limited to reconfiguring a device, adding a new device, removing a device (and not necessarily the device prone to fault), reprogramming of a device, deactivation of a device, and other possible actions as appropriate to a given device.

Computer 114 is responsible for the prediction of which device or devices in information technology environment 100 are prone to failure. Computer 114 may be part of information technology environment 100, but could also be separate from 100 and merely in communication with the devices in information technology environment 100 or possibly in communication with controller 116 responsible for overseeing information technology environment 100.

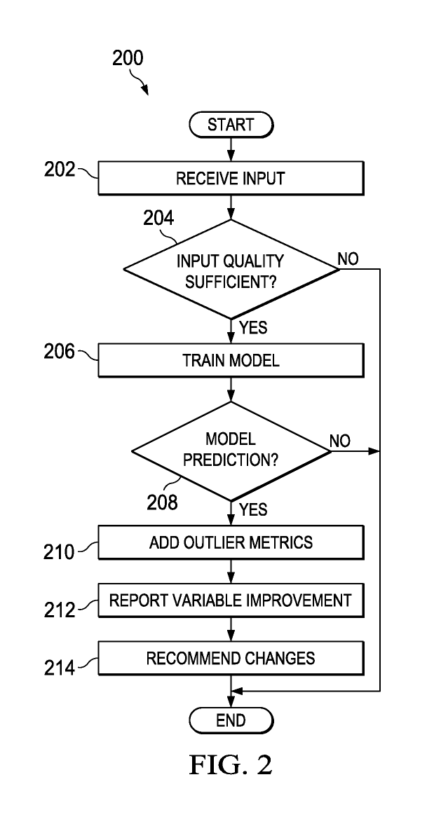

Computer may include processor 118 and non-transitory computer recordable storage medium 120. Non-transitory computer recordable storage medium 120 may include software such as machine learning 122. Machine learning 122 uses input data from information technology environment 100. Input data may include, but is not limited to, trouble ticket descriptions and resolutions, utilization of central processing units, memory, disks, data throughput, device architecture, device age, operating system families and versions, and other information. Machine learning 122 identifies the device or devices prone to failure. The illustrative embodiments described with respect to FIG. 2 through FIG. 5 provide for improvements to this process.

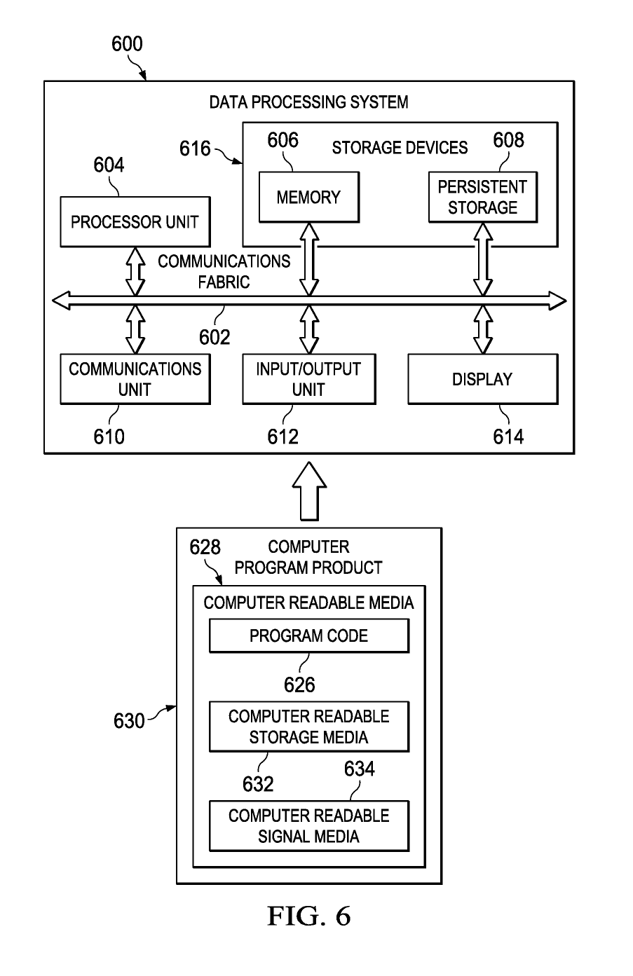

FIG. 2 is a flowchart of a computer implemented method, in accordance with an illustrative embodiment. In particular, method 200 is a method for using outlier information to predict possible failure of a device or devices in an information technology environment, such as information technology environment 100 of FIG. 1. Method 200 may be implemented by a processor as part of execution of a machine learning program. An example of such a processor is processor 118 of FIG. 1 or processor unit 604 in FIG. 6.

As used herein, an outlier is defined as a low proximity level between an output of a hardware device and a forest. Two sets of training data in the machine learning program can be said to have close proximity if they are categorized into the sane leaf of a number of trees in a forest. A forest is a group of tree classifiers used in machine learning. The output of the forest for a feature set with a low strangeness value (that is, a feature set that is typical of those used in building the forest) should be considered to be more reliable than the output for a feature set with a high strangeness value.

Method 200 may begin by the processor receiving input (operation 202). Input may include, but is not limited to, trouble ticket descriptions and resolutions, utilization of central processing units, memory, disks, data throughput, device architecture, device age, operating system families and versions, and other information. Next, the processor determines whether the input quality of the data is sufficient (operation 204). If not, the method may terminate thereafter. If so, then the processor trains the model (operation 206). This operation is part of the machine learning program.

Method 200 then continues by the processor determining whether a model prediction should be determined (operation 208). If not, the method may terminate thereafter. If so, then method 200 also includes the processor adding outlier metrics to the training model (operation 210). The processor then reports variable improvement (operation 212). The processor then provides recommended changes to the information technology environment (operation 214). In one illustrative embodiment, the method may terminate thereafter.

Method 200 may be varied. More or fewer operations may be present. Each operation may contain one or more sub-steps. Thus, method 200 of FIG. 2 does not necessarily limit the claimed inventions.

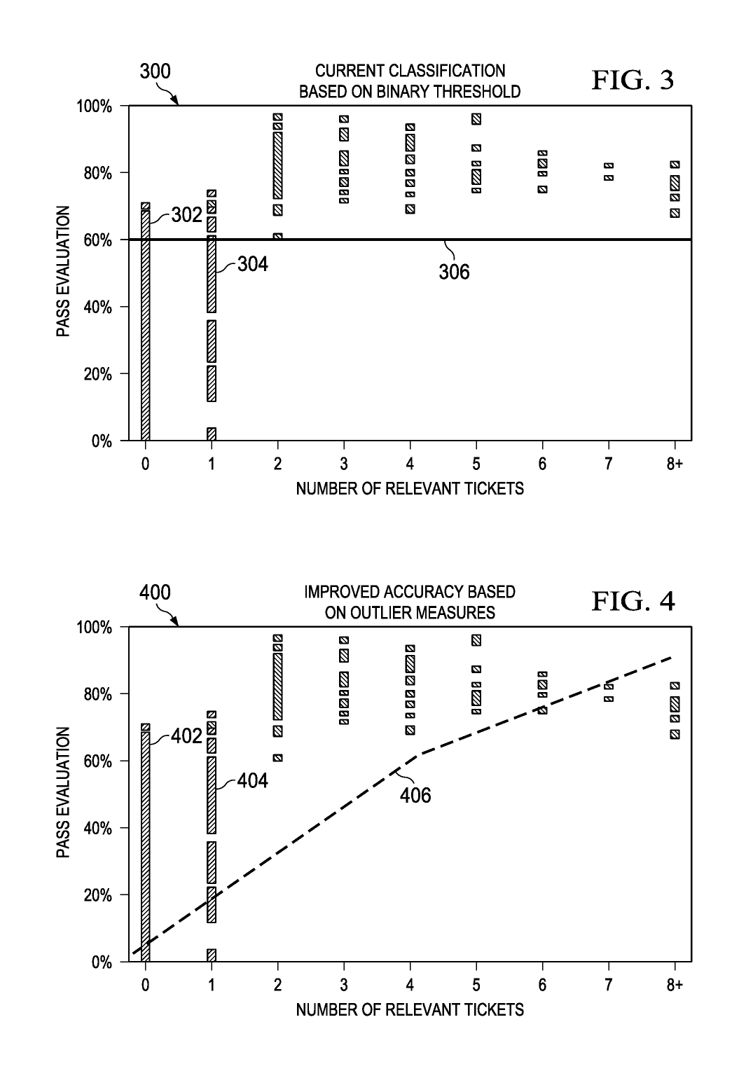

FIG. 3 is a graph of a current classification based on a binary threshold, in accordance with an illustrative embodiment. FIG. 4 is a graph of improved accuracy based on outlier measures relative to the current classification shown in FIG. 3, in accordance with an illustrative embodiment. FIG. 3 and FIG. 4 should be read together. Both graph 300 and graph 400 are graphs of the number of relevant tickets (trouble tickets or trouble reports) on the horizontal axis versus the pass evaluation percentage on the vertical axis. In both cases, the number of relevant tickets for a given type is the same.

The data appear to form columns because the ticket count is an integer value, so the points are all lined up vertically over the ticket count integer values on the horizontal axis. Thus, each column is a collection of data points. The horizontal axis in each Figure is the more nuanced total number of severity 1 and severity 2 tickets during the same date window. The illustrative embodiments contemplate industry standard definitions of “severity 1” and “severity 2” tickets. Those with more outages should get a higher failure probability output.

The columns of data points labelled column 302 and column 402 represent systems with no relevant tickets, which are therefore all labelled as “non-problematic.” The definition of “problematic” in this particular case is any “severity 1” or more than one “severity 2” outage during the date window being considered. Column 304 and column 404, representing systems with one ticket, are mostly “non-problematic,” although a minority of systems with a single “severity 1” ticket are labelled “problematic,” as represented by a different pattern. The remainder of both figures, representing data points for systems with two or more “severity 1” or “severity 2” tickets, are all labelled “problematic,” as identified by the pattern matching the minority of “problematic” data points in column 304 and column 404.

The graph in 400 is the same graph as 300, but with line 306 and line 406 drawn to show the trend that would be more desirable (namely line 406 shows a more desirable trend). Line 306 is a tolerance cut-off (above the line is considered to have been evaluated as “problematic” and below is “non-problematic” for model quality evaluation purposes). Line 406 is, again, the more desirable general trend that would indicate a generally more problematic evaluation for the devices that receive more tickets. The better that sort of trend can be approached, the more confident one can be about moving from using cut-off lines, like line 306, to split the output into binary classifications, and using instead a graded scale of risk.

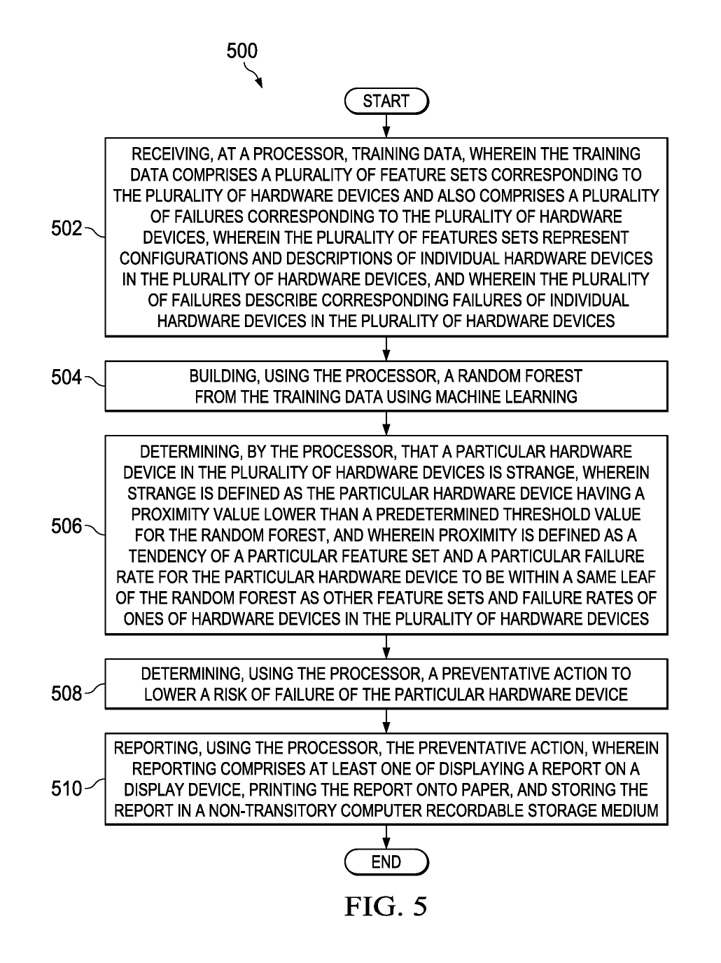

FIG. 5 is a flowchart of a computer-implemented method, in accordance with an illustrative embodiment. Method 500 is a variation on method 200 of FIG. 2. Method 500 is also a method for carrying out the techniques described with respect to FIG. 1. Method 500 may be implemented using a processor, such as processor 118 of FIG. 1 or processor unit 604 of FIG. 6. Method 500 may be characterized as a computer-implemented method of increasing reliability of an information technology environment comprising a plurality of hardware devices.

Method 500 includes receiving, at a processor, training data, wherein the training data comprises a plurality of feature sets corresponding to the plurality of hardware devices and also comprises a plurality of failures corresponding to the plurality of hardware devices, wherein the plurality of feature sets represent configurations and descriptions of individual hardware devices in the plurality of hardware devices, and wherein the plurality of failures describe corresponding failures of individual hardware devices in the plurality of hardware devices (operation 502). The method also includes building, using the processor, a random forest from the training data using machine learning (operation 504). The method also includes determining, by the processor, that a particular hardware device in the plurality of hardware devices is strange, wherein strange is defined as the particular hardware device having a proximity value lower than a predetermined threshold value for the random forest, and wherein proximity is defined as a tendency of a particular feature set and a particular failure rate for the particular hardware device to be within a same leaf of the random forest as other feature sets and failure rates of ones of hardware devices in the plurality of hardware devices (operation 506). The method also includes determining, using the processor, a preventative action to lower a risk of failure of the particular hardware device (operation 508). The method also includes reporting, using the processor, the preventative action, wherein reporting comprises at least one of displaying a report on a display device, printing the report onto paper, and storing the report in a non-transitory computer recordable storage medium (operation 510). In one illustrative embodiment, the method may terminate thereafter.

Method 500 may include more or fewer operations. For example, the training data includes analysis of ticket descriptions, ticket resolutions, CPU information, memory information, disk throughput information, device architecture information, device ages, operating system families, and operating system versions. The predetermined threshold may be moveable along a sliding scale of strangeness. In other words, the definition of when a hardware device is “strange enough” for action to be taken may change.

Method 500 may also include the additional operation of taking the preventative action. In some cases, taking the preventative action may be performed by a processor automatically configuring a device. Thus, for example, in an illustrative embodiment the preventative action may be reconfiguring the third hardware device. However, in other cases, the preventative action may be taken by a technician or other human user. In another example, the preventative action may be replacing the third hardware device. In still another example, the preventative action may be adding a new hardware device to the plurality of hardware devices. In yet another example, the preventive action may be removing a different hardware device from among the plurality of hardware devices. Other actions may be performed.

Thus, the illustrative embodiments are not necessarily limited to the examples provided with respect to FIG. 5. More or fewer operations may be present, and the above operations may be varied. Additional sub-operations may be present.

With reference now to FIG. 6, a diagram of a data processing system is depicted in accordance with an illustrative embodiment. Data processing system 600 is an example of a computer, in which computer readable program code or program instructions implementing processes of illustrative embodiments may be located. In this illustrative example, data processing system 600 includes communications fabric 602, which provides communications between processor unit 604, memory 606, persistent storage 608, communications unit 610, input/output unit 612, and display 614.

Processor unit 604 serves to execute instructions for software applications and programs that may be loaded into memory 606. Processor unit 604 may be a set of one or more hardware processor devices or may be a multi-processor core, depending on the particular implementation. Further, processor unit 604 may be implemented using one or more heterogeneous processor systems, in which a main processor is present with secondary processors on a single chip. As another illustrative example, processor unit 604 may be a symmetric multi-processor system containing multiple processors of the same type.

Memory 606 and persistent storage 608 are examples of storage devices 616. A computer readable storage device is any piece of hardware that is capable of storing information, such as, for example, without limitation, data, computer readable program code in functional form, and/or other suitable information either on a transient basis and/or a persistent basis. Further, a computer readable storage device excludes a propagation medium. Memory 606, in these examples, may be, for example, a random access memory, or any other suitable volatile or non-volatile storage device. Persistent storage 608 may take various forms, depending on the particular implementation. For example, persistent storage 608 may contain one or more devices. For example, persistent storage 608 may be a hard drive, a flash memory, a rewritable optical disk, a rewritable magnetic tape, or some combination of the above. The media used by persistent storage 608 may be removable. For example, a removable hard drive may be used for persistent storage 608.

Communications unit 610, in this example, provides for communication with other computers, data processing systems, and devices via network communications unit 610 may provide communications using both physical and wireless communications links. The physical communications link may utilize, for example, a wire, cable, universal serial bus, or any other physical technology to establish a physical communications link for data processing system 600. The wireless communications link may utilize, for example, shortwave, high frequency, ultra-high frequency, microwave, wireless fidelity (WiFi), Bluetooth technology, global system for mobile communications (GSM), code division multiple access (CDMA), second-generation (2G), third-generation (3G), fourth-generation (4G), 4G Long Term Evolution (LTE), LTE Advanced, or any other wireless communication technology or standard to establish a wireless communications link for data processing system 600.

Input/output unit 612 allows for the input and output of data with other devices that may be connected to data processing system 600. For example, input/output unit 612 may provide a connection for user input through a keypad, keyboard, and/or some other suitable input device. Display 614 provides a mechanism to display information to a user and may include touch screen capabilities to allow the user to make on-screen selections through user interfaces or input data, for example.

Instructions for the operating system, applications, and/or programs may be located in storage devices 616, which are in communication with processor unit 604 through communications fabric 602. In this illustrative example, the instructions are in a functional form on persistent storage 608. These instructions may be loaded into memory 606 for running by processor unit 604. The processes of the different embodiments may be performed by processor unit 604 using computer implemented program instructions, which may be located in a memory, such as memory 606. These program instructions are referred to as program code, computer usable program code, or computer readable program code that may be read and run by a processor in processor unit 604. The program code, in the different embodiments, may be embodied on different physical computer readable storage devices, such as memory 606 or persistent storage 608.

Program code 626 is located in a functional form on computer readable media 628 that is selectively removable and may be loaded onto or transferred to data processing system 600 for running by processor unit 604. Program code 626 and computer readable media 628 form computer program product 630. In one example, computer readable media 628 may be computer readable storage media 632 or computer readable signal media 634. Computer readable storage media 632 may include, for example, an optical or magnetic disc that is inserted or placed into a drive or other device that is part of persistent storage 608 for transfer onto a storage device, such as a hard drive, that is part of persistent storage 608. Computer readable storage media 632 also may take the form of a persistent storage, such as a hard drive, a thumb drive, or a flash memory that is connected to data processing system 600. In some instances, computer readable storage media 632 may not be removable from data processing system 600.

Alternatively, program code 626 may be transferred to data processing system 600 using computer readable signal media 634. Computer readable signal media 634 may be, for example, a propagated data signal containing program code 626. For example, computer readable signal media 634 may be an electro-magnetic signal, an optical signal, and/or any other suitable type of signal. These signals may be transmitted over communication links, such as wireless communication links, an optical fiber cable, a coaxial cable, a wire, and/or any other suitable type of communications link. In other words, the communications link and/or the connection may be physical or wireless in the illustrative examples. The computer readable media also may take the form of non-tangible media, such as communication links or wireless transmissions containing the program code.

In some illustrative embodiments, program code 626 may be downloaded over a network to persistent storage 608 from another device or data processing system through computer readable signal media 634 for use within data processing system 600. For instance, program code stored in a computer readable storage media in a data processing system may be downloaded over a network from the data processing system to data processing system 600. The data processing system providing program code 626 may be a server computer, a client computer, or some other device capable of storing and transmitting program code 626.

The different components illustrated for data processing system 600 are not meant to provide architectural limitations to the manner in which different embodiments may be implemented. The different illustrative embodiments may be implemented in a data processing system including components in addition to, or in place of, those illustrated for data processing system 600. Other components shown in FIG. 6 can be varied from the illustrative examples shown. The different embodiments may be implemented using any hardware device or system capable of executing program code. As one example, data processing system 600 may include organic components integrated with inorganic components and/or may be comprised entirely of organic components excluding a human being. For example, a storage device may be comprised of an organic semiconductor.

As another example, a computer readable storage device in data processing system 600 is any hardware apparatus that may store data. Memory 606, persistent storage 608, and computer readable storage media 632 are examples of physical storage devices in a tangible form.

In another example, a bus system may be used to implement communications fabric 602 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 606 or a cache such as found in an interface and memory controller hub that may be present in communications fabric 602.

The present invention may be a system, a method, and/or a computer program product. The computer program product may include a computer readable storage medium or media having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer readable program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function or functions. In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Thus, illustrative embodiments of the present invention provide a computer implemented method, computer system, and computer program product for improving security on a computer system by identifying compromised or potentially compromised APIs using machine learning algorithms. Optionally, only identified APIs may be subjected to static testing, as is known in the art.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function or functions. It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer-implemented method of increasing reliability of an information technology environment comprising a plurality of hardware devices, the method comprising:
receiving, at a processor, training data, wherein the training data comprises a plurality of feature sets corresponding to the plurality of hardware devices and also comprises a plurality of failures corresponding to the plurality of hardware devices, wherein the plurality of feature sets represent configurations and descriptions of individual hardware devices in the plurality of hardware devices, and wherein the plurality of failures describe corresponding failures of individual hardware devices in the plurality of hardware devices;
building, using the processor, a random forest from the training data using machine learning;
determining, by the processor, that a particular hardware device in the plurality of hardware devices is strange, wherein strange is defined as the particular hardware device having a proximity value lower than a predetermined threshold value for the random forest, and wherein proximity is defined as a tendency of a particular feature set and a particular failure rate for the particular hardware device to be within a same leaf of the random forest as other feature sets and failure rates of ones of hardware devices in the plurality of hardware devices;
determining, using the processor, a preventative action to lower a risk of failure of the particular hardware device; and
reporting, using the processor, the preventative action, wherein reporting comprises at least one of displaying a report on a display device, printing the report onto paper, and storing the report in a non-transitory computer recordable storage medium.

2. The computer-implemented method of claim 1, wherein the training data includes analysis of ticket descriptions, ticket resolutions, CPU information, memory information, disk throughput information, device architecture information, device ages, operating system families, and operating system versions.

3. The computer-implemented method of claim 1, wherein the predetermined threshold is moveable along a sliding scale of strangeness.

4. The computer-implemented method of claim 1 further comprising:
taking the preventative action.

5. The computer-implemented method of claim 4, wherein the preventative action comprises reconfiguring the particular hardware device.

6. The computer-implemented method of claim 4, wherein the preventative action comprises replacing the particular hardware device.

7. The computer-implemented method of claim 4, wherein the preventative action comprises adding a new hardware device to the plurality of hardware devices.

8. The computer-implemented method of claim 4, wherein the preventive action comprises removing a different hardware device from among the plurality of hardware devices.

9. A computer comprising:
a processor;
a bus connected to the processor;
a non-transitory computer recordable storage medium connected to the bus and storing program code which, when implemented by the processor, performs a computer-implemented method of increasing reliability of an information technology environment comprising a plurality of hardware devices, the program code comprising:
program code for receiving, at the processor, training data, wherein the training data comprises a plurality of feature sets corresponding to the plurality of hardware devices and also comprises a plurality of failures corresponding to the plurality of hardware devices, wherein the plurality of feature sets represent configurations and descriptions of individual hardware devices in the plurality of hardware devices, and wherein the plurality of failures describe corresponding failures of individual hardware devices in the plurality of hardware devices;
program code for building, using the processor, a random forest from the training data using machine learning;
program code for determining, by the processor, that a particular hardware device in the plurality of hardware devices is strange, wherein strange is defined as the particular hardware device having a proximity value lower than a predetermined threshold value for the random forest, and wherein proximity is defined as a tendency of a particular feature set and a particular failure rate for the particular hardware device to be within a same leaf of the random forest as other feature sets and failure rates of ones of hardware devices in the plurality of hardware devices;
program code for determining, using the processor, a preventative action to lower a risk of failure of the particular hardware device; and
program code for reporting, using the processor, the preventative action, wherein reporting comprises at least one of displaying a report on a display device, printing the report onto paper, and storing the report in a non-transitory computer recordable storage medium.

10. The computer of claim 9, wherein the training data includes analysis of ticket descriptions, ticket resolutions, CPU information, memory information, disk throughput information, device architecture information, device ages, operating system families, and operating system versions.

11. The computer of claim 9, wherein the non-transitory computer recordable storage medium further stores program code for moving the predetermined threshold along a sliding scale of strangeness.

12. The computer of claim 9, wherein the non-transitory computer recordable storage medium further stores program code for taking the preventative action.

13. The computer of claim 12, wherein the program code for taking the preventative action comprises program code for reconfiguring the particular hardware device.

14. The computer of claim 12, wherein the program code for taking the preventive action comprises program code for removing the particular hardware device from among the plurality of hardware devices.

15. A non-transitory computer recordable storage medium storing program code which, when implemented by a processor, performs a computer-implemented method of increasing reliability of an information technology environment comprising a plurality of hardware devices, the program code comprising:
program code for receiving, at the processor, training data, wherein the training data comprises a plurality of feature sets corresponding to the plurality of hardware devices and also comprises a plurality of failures corresponding to the plurality of hardware devices, wherein the plurality of feature sets represent configurations and descriptions of individual hardware devices in the plurality of hardware devices, and wherein the plurality of failures describe corresponding failures of individual hardware devices in the plurality of hardware devices;
program code for building, using the processor, a random forest from the training data using machine learning;
program code for determining, by the processor, that a particular hardware device in the plurality of hardware devices is strange, wherein strange is defined as the particular hardware device having a proximity value lower than a predetermined threshold value for the random forest, and wherein proximity is defined as a tendency of a particular feature set and a particular failure rate for the particular hardware device to be within a same leaf of the random forest as other feature sets and failure rates of ones of hardware devices in the plurality of hardware devices;
program code for determining, using the processor, a preventative action to lower a risk of failure of the particular hardware device; and
program code for reporting, using the processor, the preventative action, wherein reporting comprises at least one of displaying a report on a display device, printing the report onto paper, and storing the report in a non-transitory computer recordable storage medium.

16. The non-transitory computer recordable storage medium of claim 15, wherein the training data includes analysis of ticket descriptions, ticket resolutions, CPU information, memory information, disk throughput information, device architecture information, device ages, operating system families, and operating system versions.

17. The non-transitory computer recordable storage medium of claim 15, wherein the program code further comprises program code for moving the predetermined threshold along a sliding scale of strangeness.

18. The non-transitory computer recordable storage medium of claim 15, wherein the program code further comprises:
program code for taking the preventative action.

19. The non-transitory computer recordable storage medium of claim 18, wherein the program code for taking the preventative action comprises program code for reconfiguring the particular hardware device.

20. The non-transitory computer recordable storage medium of claim 18, wherein the program code for taking the preventive action comprises program code for removing a different hardware device from among the plurality of hardware devices.
